(19) United States
(12) Patent Application Publication
(10) Pub. No.: US 2009/0287584 A1
(43) Pub. Date: Nov. 19, 2009

(54) SYSTEMS AND METHODS FOR PROVIDING INFORMATION ASSOCIATED WITH PRODUCT SAMPLES

(75) Inventor: James Steven Brown, Gilbert, AZ (US)

Correspondence Address: Ingrassia Fisher & Lorenz, P.C. (FLORATECH), 7010 East Cochise Road, Scottsdale, AZ, 85253-1406, US

(73) Assignee: INTERNATIONAL FLORA TECHNOLOGIES, LTD., Chandler, AZ (US)

(21) Appl. No.: 12/464,729

(22) Filed: May 12, 2009

Related U.S. Application Data
(60) Provisional application No. 61/052,990, filed on May 13, 2008.

(51) Int. Cl. G06Q 30/00; G06Q 50/00; G06F 17/30

(52) U.S. Cl. 705/26; 707/3; 235/383; 707/E17.014; 707/E17.044

(57) ABSTRACT

Systems and methods are described for providing information associated with a particular product to a customer possessing a sample of the particular product. An identifier that is provided with the sample of the particular product and that uniquely identifies the product is received at a server. The information associated with the particular product is obtained based upon the received identifier. The information is provided from the server to the customer to thereby allow the customer to use the particular product that is in the customer's possession. The information provided may include safety information (e.g., a material safety data sheet (MSDS)) and usage information associated with the particular product. Such systems and methods may be particularly useful providing information relating to chemical components, such as those used in cosmetic, personal care or other industries.

### PRIORITY CLAIM

This application claims priority of U.S. Provisional Patent Application Ser. No. 61/052,990, which was filed on May 13, 2008 and is incorporated herein by reference in its entirety.

### TECHNICAL FIELD

The following discussion generally relates to systems and techniques for providing information associated with products. More particularly, the following discussion provides examples of several systems and techniques for providing information to customers related to products that may be in the possession of the customer or other user.

### BACKGROUND

Numerous chemical formulations and other products are often associated with a relatively large volume of sales, usage, safety and/or other information. Organic or inorganic chemical components used in cosmetic, personal care and other industries, for example, are often associated with safety information (e.g., material safety data sheets (MSDSs), as well as regulatory information, instructions for usage, test results and/or the like. To create a cosmetic, personal care or other product that incorporates the chemical component, then, a customer typically needs access to several different types of information relating to the component.

To provide just one example, if a cosmetic formulator desires to create a new facial cream, the formulator may be looking for a suitable emollient component to use in the new product. The formulator would typically evaluate several different emollient components (e.g., almond oil, olive oil, shea butter, jojoba oil, and/or the like) to find one that is suitable for the particular product. In addition to evaluating the effectiveness of each component, the formulator will frequently have numerous questions regarding the suitability of the component for use in the product. For example, the formulator may need to know if the particular component is approved for use in target markets, if the component has been tested on animals, if the component's manufacturing process uses certain solvents, if the product will dissolve into certain other components (e.g., silicone derivatives), if the product is free of heavy metals, and the like. Additionally, the formulator may need to know technical, safety, toxicity and/or other information, such as information conventionally contained on an MSDS.

Frequently, the evaluator will have access to a product sample for evaluation. Product samples, however, are generally relatively small in size, so it is not convenient to print all of the relevant information about each product on a product label. To obtain additional information about the particular sample, customers generally submit a manual request to the component manufacturer via telephone, email or the like. This request is typically manually processed by a sales representative, call center operator or other human customer service representative. This process can be cumbersome and time consuming for the customer, particularly if geography, time zones, language differences and/or other logistical barriers exist between the customer and the person providing the information. Moreover, the costs of human labor and other capital involved in call centers or other customer service facilities can be significant.

It is therefore desirable to create systems and methods for providing information about particular products to customers that are efficient and effective. These and other desirable features and characteristics will become apparent from the subsequent detailed description and the appended claims, taken in conjunction with the accompanying drawings and this background section.

### BRIEF DESCRIPTION

Various systems and methods are described for providing information associated with a particular product to a customer possessing a sample of the particular product. In one exemplary embodiment, an identifier that is provided with the sample of the particular product and that uniquely identifies the product is received at a server system, such as any sort of Internet web server. The information associated with the particular product is obtained based upon the received identifier. The information is provided from the server to the customer to thereby allow the customer to use the sample of the particular product that is in the customer's possession. The information provided may include safety and usage information that is associated with the particular product. Such systems and methods may be particularly useful providing information relating to chemical products, such as component products that are used in cosmetic, personal care or other industries.

Certain other embodiments provide a method executable by a server or other system for providing information associated with a particular product that is a component of a cosmetic or personal care product to a customer that possesses a sample of the particular product. The method initially involves receiving, by the server, an identifier from the customer, wherein the identifier is provided with the particular product and uniquely identifies the particular component based upon a production lot of the particular component. The information associated with the particular product is obtained at the server based upon the received identifier, wherein the information comprises chemical nomenclature information about the particular product, safety information associated with the particular product, and usage information that comprises a formula for the cosmetic or personal care product comprising the particular product. The information is then provided from the server to the customer to thereby allow the customer to create the cosmetic or personal care product based upon the formula and the sample of the particular product that is in the customer's possession.

The various implementations may be enhanced or modified in many different ways to create any number of alternate embodiments. Products or components of products may be identified based upon particular manufacturing lots, UPC codes, SKU numbers, serial numbers or any other identifiers, for example, to allow for very accurate information associated with the particular product to be retrieved on a convenient basis. Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary system for providing information to customers;

FIG. 2 a flowchart of an exemplary system for providing information associated with an identified particular product;

FIG. 3 is an exemplary label that includes an identifier and that may be associated with a product sample or the like;

FIG. 4 is an exemplary user interface for receiving identifiers associated with particular product samples; and

FIG. 5 is an exemplary user interface for providing information associated with a particular product.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

According to various embodiments, a network-based server system is provided in communication with the Internet or a similar communications network that allows customers to identify the particular product samples in their possession and to obtain much (if not all) of the information needed to use the product in a convenient and rapid manner. In various embodiments, samples of particular products are labeled or otherwise marked with identifiers that uniquely identify the particular product in the customer's possession. Identifiers may be specific to manufacturing lots, universal product code (UPC) values, stock-keeping unit (SKU) numbers or other product identification codes, serial numbers and/or the like to provide whatever level of detail may be needed in a particular embodiment. To obtain information about a particular product, the customer simply opens a web page (or other interface) to a relevant address, provides the identifier associated with the particular product, and then retrieves whatever information may be desired. In various embodiments, the information is provided at a particular Internet uniform resource locator (URL) or other address that is printed or otherwise indicated on the product sample itself. In such embodiments, a customer can obtain any amount of relevant information about a product by simply possessing the sample of the product.

Further, the identifier provided on the product sample may be used to provide information about the particular product that is contained in the customer's particular sample with a relatively high level of particularity. If the identifier relates to a manufacturing lot of the sample, for example, information unique to that lot can be provided. In embodiments that use identifiers based upon manufacturing lots, for example, the information provided about the particular product can reflect minor variations in ingredients or manufacturing processes between different lots, or other lot-specific information as desired. Other embodiments may provide information unique to particular UPC or SKU numbers, serial numbers or other identifiers as appropriate. By providing information based upon an identifier provided with the product sample, the customer is provided with information that is uniquely tailored to that particular sample (or group of samples). Hence, information that is specific to the product in the customer's possession can be provided in a convenient, flexible and effective manner.

The general concepts described herein are often described with respect to cosmetic or personal care products for convenience. Equivalent concepts, however, may be applied to bulk chemicals or any other products wherein it is desirable to provide convenient retrieval of product information. Similarly, the types of information that may be provided could vary significantly from embodiment to embodiment. The particular examples below, for example, may emphasize MSDS and other safety information that may be provided in conjunction with any product usage data and/or the like. Equivalent embodiments may provide different types of safety or usage data, or may provide different types of data entirely.

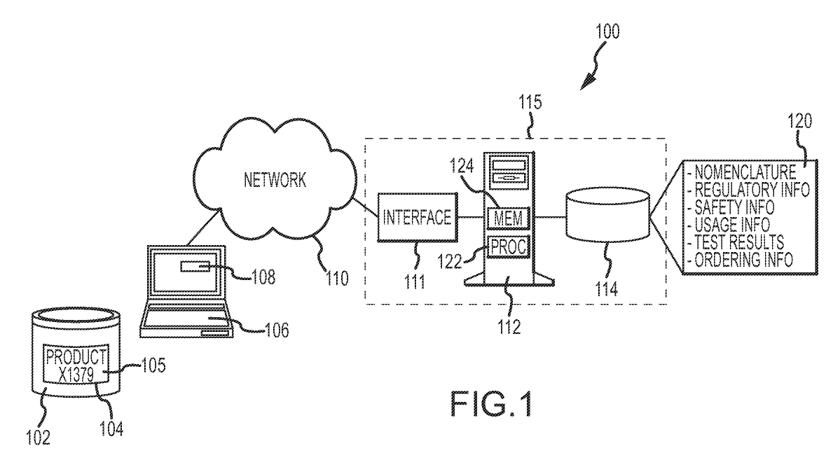

Turning now to the drawing figures and with initial reference to FIG. 1, an exemplary system 100 for providing information about a sample 102 of a particular product suitably includes a server system 115 that includes an interface 111 to a digital network 110, a controller 112, and a database 114 that contains relevant information 120 about any number of particular products. The customer is able to access server system 115 using a client computer or the like via network 110.

Customers obtain information about particular products by providing an identifier 104 that uniquely identifies the relevant product to system 115. Generally, identifier 104 is obtained from a printed label 105 or other indication that is present on the sample 102 itself, or its packaging. A customer that is in possession of a sample 102 of the product may therefore obtain the directly identifier 104 from the label, packaging or the like. The sample 102 itself may also provide a URL or other address associated with server 115 that tells the customer where to provide the identifier 104 to obtain more information about the particular product.

The customer provides the identifier 104 to server 115 in any manner. In various embodiments, the customer uses a conventional client system 106 to access server 115 via network 110. In various embodiments, network 110 includes the Internet and/or any sort of public, private or hybrid network, including any sort of wired or wireless telephone network. To that end, client system 106 is any sort of computer, workstation, mobile phone, personal digital assistant, web-browsing device and/or other client node that is capable of communicating on network 110. In various embodiments, client system 106 contains a processor and memory, as well as any conventional mass storage, input/output features and/or the like. Client computer may include any sort of operating system or other programming environment capable of executing any conventional browser program (e.g., the INTERNET EXPLORER browser available from the MICROSOFT CORPORATION of Redmond, Wash., or any other browser program executing in any computing environment, operating system or the like). Client system 106 may establish the connection to server 115 over network 110 using any techniques or protocols, including any techniques for direct access (e.g., using the URL or other address provided on product sample 102), indirect access (e.g., by identifying server 115 though a search engine or other redirector), or any other technique. In various embodiments, the connection established is a conventional secure or unsecure hypertext transport protocol (HTTP) connection using conventional TCP/IP networking techniques and protocols, although other embodiments may use other underlying connections, protocols and the like.

Server system 115 is any computer-based or other data processing system capable of providing information 120 related to particular products to client systems 106 via network 110. Server system 115 may be implemented within a single device, such as any sort of personal computer, server, workstation or other processor-based system in some embodiments. In such cases, interface 111, controller 112 and database 114 may be combined within a common housing or other chassis, and may execute on common processing circuitry. Other embodiments, however, will implement system 115 using separate processors for interface/border control, information processing and data storage.

In various embodiments, server system 115 is a conventional internet-type server that communicates with network 110 via any appropriate interface 111. To that end, interface 111 may be implemented with any suitable hardware, software or combination of the two capable of facilitating communications between controller 112 and client computer 106. In some embodiments, interface 111 may include any sort of routing, load balancing, firewall or other security and/or other features as appropriate to facilitate communications on network 110 by a separate processing system (e.g., controller 112). In other embodiments, interface 111 is a conventional network interface card or other interface residing within a personal computer, workstation or other host platform capable of providing the various functions described herein.

Controller 112 is any computer hardware, software or combination thereof capable of processing requests for information received from network 110. In various embodiments, controller 112 has a processor 122 and memory 124 that allow for execution of instructions and storage of data on a temporary or other basis. Controller 112 may be a conventional “web server” system based upon any hardware or software components.

Database 114 is any hardware, software or combination thereof capable of maintaining information 120 about various products for retrieval by controller 112 as appropriate. In various embodiments, database 114 is any soft of hierarchical, relational, object-oriented or other database capable of storing data about various products in any format. Information 120 may be organized in any manner. Such information may be organized so that the identifiers 104 associated with the various products are stored in a “key” field to facilitate rapid information retrieval, although other databases 114 may be differently structured in any manner. Database 114 may be stored on a hard disk drive or other mass storage associated with system 115 or controller 112 in some embodiments. In other embodiments, database 114 is maintained in a client-server environment with a database server providing a front-end to data queries (e.g., structured query language (SQL) or other queries) posited by controller 112 or any other appropriate source. Such queries may be provided across a secure local area network interconnecting database 115 and controller 112, although other topologies and architectures could be equivalently applied.

The particular information 120 stored in database 114 will vary significantly from embodiment to embodiment based upon the particular product(s) supported. In an exemplary embodiment, information 120 may include chemical nomenclature, regulatory information, safety information (e.g., MSDS documents), usage information, test results, ordering information, marketing information, coding package or other product information, and/or the like. Various examples of data that could be provided in different embodiments are described more fully below.

In various embodiments, server 115 uses conventional web server and database technology to provide information 120 to the client systems 106 in any convenient manner. Documents making up the various types of information may be formatted in any manner (e.g., portable document format (PDF) or any other document exchange format) and stored within database 114 for subsequent retrieval. Document selection, retrieval and forwarding may be handled using conventional web-based techniques, including any techniques based upon active server pages (ASP), common gateway interface (CGI/PHP), hypertext markup language (HTML/XML) and/or any other technologies as appropriate.

In operation, then, the customer typically obtains the identifier 104 associated with a particular sample 102 of a product. This identifier 104 may be present on a label 105 or other packaging feature, as appropriate. Typically, the customer establishes a HTML or other connection from client system 106 to server system 115 (e.g., using a URL also found on sample 102), and enters the identifier 104 into a text entry window 108 or the like. Other embodiments may allow data entry through optical character recognition (OCR), bar code scanning, RFID reading or any other automated techniques.

Controller 112 suitably receives the identifier 104 via network 110 and interface 111. This identifier 104 can be used to posit a query to database 114 to obtain any information 120 associated with the particular sample 102 in the customer's possession. The particular information 120 may then be provided to the customer in any manner. In embodiments wherein identifier 104 relates to a manufacturing lot or the like, information that is unique to that particular lot can be provided. Hence, a customer that possesses an actual sample 102 of a product can obtain information that is uniquely relevant to that particular sample, or that particular batch of samples. Similarly information that is not relevant to that particular sample 102 can be excluded, as appropriate. Recall information, for example, could be provided on a lot-specific basis to allow consumers convenient access to information associated with the particular product that is in their possession. In such embodiments, customers that possess samples from a recalled manufacturing lot could be notified of a recall, whereas customers possessing samples from a non-recalled lot would not need to receive information about the recall. Similar concepts could be applied to other information (e.g., to reflect slight variances in ingredients or manufacturing techniques between manufacturing lots) as desired.

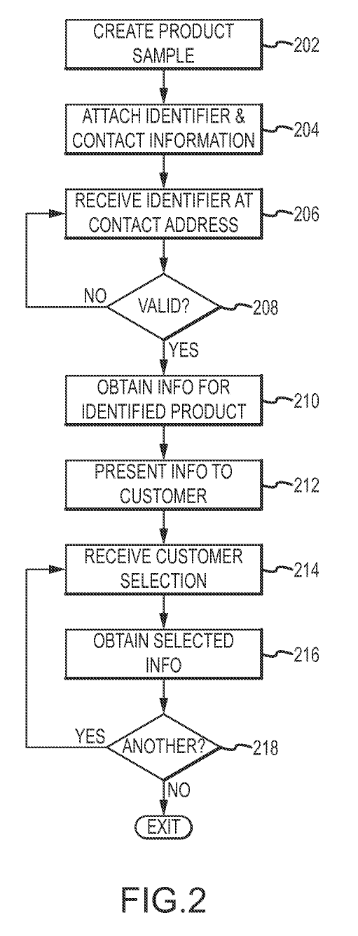

With reference now to FIG. 2, an exemplary process 200 for providing information to a customer about a particular product suitably includes the broad steps of receiving the identifier 104 from the customer (function 206), obtaining the information associated with the particular product based upon the received identifier (function 210), and providing the information to the customer (function 214) to thereby allow the customer to use the sample of the particular product that is in the customer's possession. These basic functions may be modified or supplemented in any manner.

Process 200 may be used with any number of different products. As noted above, customers frequently have a need for additional information associated with product samples 102 that may be in their possession. Function 202, then, involves creating product samples 102 of any suitable product that can be distributed to any number of customers in any manner. These products may be manually or automatically manufactured in any manner; in various embodiments, however, the products are chemical-type products that may be created in various manufacturing lots.

Identifiers 104 are attached or otherwise associated with the various product samples in any manner (function 204). In various embodiments, lot numbers or other identifiers are printed on labels that can be affixed to packaging (e.g., bottles, boxes or the like) that contain the product itself. In other embodiments, the lot number or other identifier 104 may be affixed or otherwise placed on the product itself, or the packaging associated with the product (e.g., with any sort of branding, molding, embossing, stamping or the like). The identifiers 104 may be as unique as needed to provide the level of identification needed for a particular product. In some embodiments, all of the product samples resulting from a common manufacturing lot will have the same identifier 104. In other embodiments, each sample 102 may have its own unique “serial number”, UPC code, SKU, product identification number and/or other identifier 104 as desired. Further, the product samples may be provided with a URL or other address to further aid the customer in obtaining additional information 120.

After the customer has received the product sample, information 120 may be provided in any convenient manner. As noted above, the customer may establish an internet or other connection between client system 106 and server 115 over network 110 in any manner. After a connection is established, server 115 can receive the identifier 104 from the customer in any manner (function 206). Identifier information 104 may provided manually in some embodiments (e.g., through text entry by the customer). In other embodiments, the identifier 104 may be obtained through a bar code reader, optical scanner, radio frequency identification (RFID) reader, or other input device that is able to obtain coded identifier information 104 directly from the product sample 102 in any manner. Some embodiments may check to ensure that the identifier 104 provided by the customer is valid (function 208), and the customer may be prompted to re-enter (or re-acquire) the identifier 104 if an invalid identifier is initially provided.

Once a valid identifier 104 is received, information 120 associated with the identified product is obtained from database 114 (function 210). Note that all of the information 120 associated with the identified product need not be immediately retrieved or presented to the customer. To the contrary, information may be obtained from database 114 and provided to client computer 106 using any interactive or other technique (function 212). In various embodiments, the customer is presented with a graphical user interface window that initially identifies the types of information 120 that are available, and that allows for convenient retrieval of documents or other files containing information that is subsequently requested. The customer may then obtain access to the information by clicking on buttons or other links associated with the identified files/documents, as appropriate. In the exemplary embodiment shown in FIG. 2, then, the customer is initially presented with a listing or other indication of available information 120. As the customer selects particular documents, files or the like (function 214), the selected information 120 can be obtained from database 114 (function 216) and provided to the customer (via client system 106) as appropriate. The customer may select additional information, as desired (function 218) in embodiments that support this feature.

The various functions shown in FIG. 2 may be performed in any manner. In various embodiments, many of the functions (e.g., functions 206-218) may be performed by controller 112 (FIG. 1) using any sort of general or special purpose processor (e.g., processor 122) executing software instructions in any language or format. Such instructions may be stored in memory 124, mass storage, or any other digital storage medium that is accessible to controller 112. Other embodiments may perform the various functions using different hardware or software features, as appropriate.

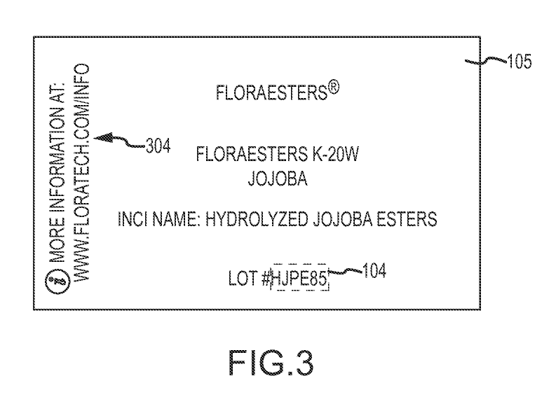

FIGS. 3-5 provide additional information about a particular implementation of a system 100 that may be used to provide information 120 about components used in cosmetic and personal care products. As noted above, equivalent concepts may be applied to any number of other products or industries. Moreover, the particular interfaces shown in FIGS. 3-5 are simply examples. The layout, arrangement, textual content, “look and feel” and other features of these figures may be modified significantly in various practical embodiments.

With reference now to FIG. 3, an exemplary label 105 is shown that may be affixed or otherwise associated with a product sample 102. In this example, an identifier 104 is provided in a clearly-legible manner, along with information 304 that provides an address (a URL in this example) for obtaining additional information. Label 105 also includes any other conventional labeling information, such as product name, International Nomenclature of Cosmetic Ingredients (INCI) name, trademark notifications, and other label information as appropriate and desired.

In this particular example, identifier 104 may be designed to encode certain information about the particular product and/or its manufacturing lot. A portion of the identifier may represent the year, month and/or day that the product was manufactured, for example. A sequential lot indication may also be provided in some embodiments. Any number of identifier schemes may be formulated to be suited to any number of products.

A customer in possession of a sample 102 having label 105 can obtain any amount of information 120 relating to the sample 102 using the information contained on label 105. By contacting the address/URL provided in information 304 and providing identifier 104, any amount of additional information 120 about this particular product sample 102 may be available to the customer. As noted above, information 120 may be associated with the identifier 104 so that only information relevant to the particular product in the customer's possession is provided. Such information may be specific to manufacturing lot, serial number, UPC code, SKU number, or any other criteria as desired.

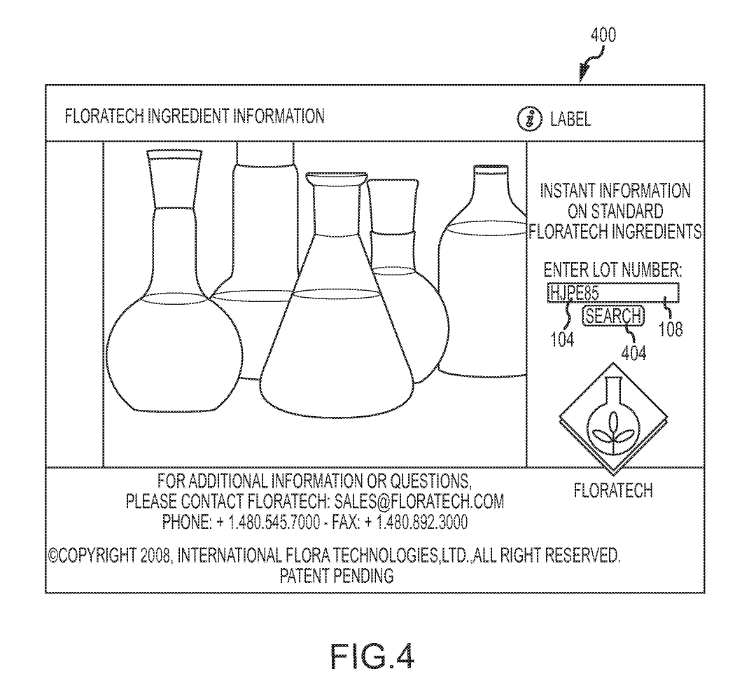

FIG. 4, for example, shows an exemplary interface 400 for receiving the identifier 104. As shown in FIG. 4, interface 400 suitably includes a text box 108 that allows for keyboard entry of identifier 104 and a search button 404 that allows the customer to initiate a search for information 120 associated with the particular sample 102 associated with the identifier 104 entered. Any additional welcoming information, help information or other features may be further provided in other embodiments.

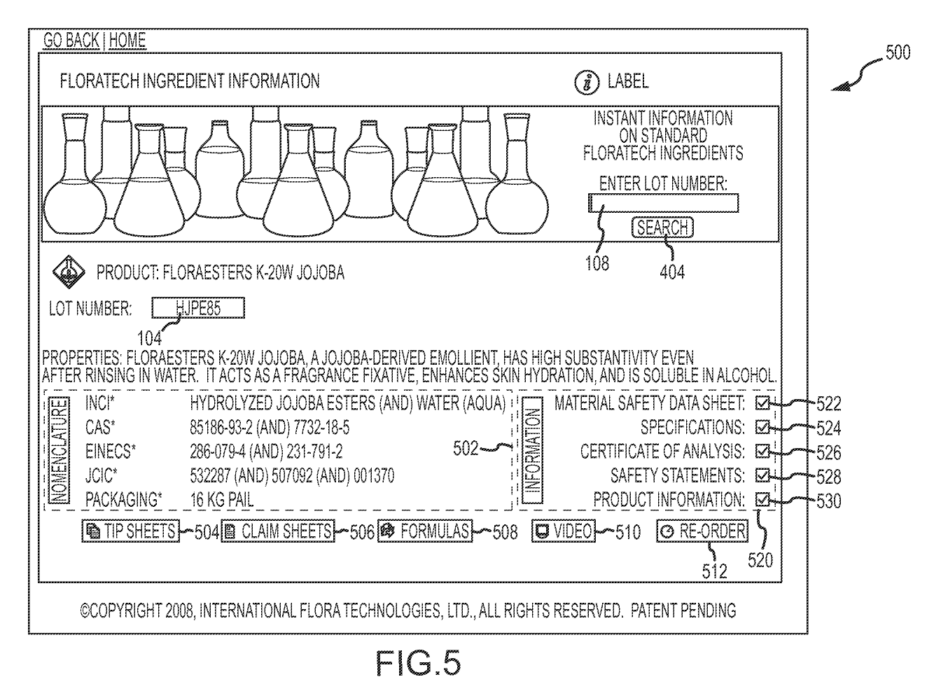

After the customer enters the identifier 104 into interface 400, system 100 suitably provides an interface such as interface 500 to present the particular information 120 associated with the particular product sample 102. In the example shown in FIG. 5, the information 120 presented suitably includes nomenclature information 502, usage information 520, safety information (e.g., MSDS 522 and safety statements 528), tip sheets 504, claim sheets 506, formulas 508, and/or any other information as appropriate. The particular example interface 500 shown in FIG. 5 also includes a feature 510 to obtain instructional videos or other media files relating to the particular product. FIG. 5 also shows a feature 512 to order additional quantities of the particular product, as well as a search feature 108, 404 for conveniently searching for information about other products. Other embodiments may provide very different information about any product, and/or may organize the interface 500 in any other manner.

As shown in FIG. 5, nomenclature information 502 suitably includes any information that is useful in identifying or describing the particular product, such as INCI names, Chemical Abstracts Service (CAS) registry numbers, European Inventory of Existing Commercial Substances (EINECS) registry data, Japan Consumer Information Center (JCIC) data, packaging data, and/or the like. This information may additionally be searchable and/or cross-linked to other products that may have similar nomenclature or other properties in some embodiments.

In the exemplary interface 500 shown in FIG. 5, information 520 includes links to files, web pages or other documents 522, 524, 526, 528, 530 that provide additional information about the particular product. Clicking (or otherwise activating) link 522, for example, would typically retrieve an MSDS associated with the particular product. Other documents that may be available in various embodiments include product specifications 524, certificates of analysis 526, safety statements 528, regulatory data (e.g., data provided to or from any governmental agency in any jurisdiction) or other product information 530 as appropriate. Such documents may be retrieved and viewed and/or printed in PDF or another document format. Alternatively, the documents may be conventional web pages prepared in HTML, XML, ASP or another conventional web-based format.

Again, alternate or additional information 120 may be provided. Such information may include, for example, coding package information (e.g., information compiled to assist customers in placing the particular product on a coded list of approved products for purchase). This coding package information may include safety information, animal testing information, environmental information, pricing data and/or other information as appropriate. This information may be provided in a desired reporting format as requested for a particular customer or industry, as appropriate.

Interface 500 as shown in FIG. 5 includes several other features that may be present in some embodiments, including tip sheets 504, claim sheets 506 and/or formulas 508. Tip sheets 504, for example, are any sort of files, web pages or other documents that provide informational “tips” in using the particular product (e.g., how to achieve a desired viscosity, how to suspend beads in a product, how to maintain product features at different pH or temperature, and/or the like). Claim sheets 506 are any files, web pages or other documents that provide support for marketing claims associated with the particular product (e.g., product reduces wrinkles, or any other improvements or benefits of using the product). Such information may include results of laboratory or field studies, Food and Drug Administration (FDA) data, or other information as desired. Formulas 508 are any recipes or other instructions for preparing manufactured end products that include the particular component. Again, tip sheets 504, claim sheets 506 and/or formulas 508 are optional features that may not be present in all embodiments, or for all products in a given embodiment.

The exemplary interface 500 of FIG. 5 also shows a link 510 to obtain one or more videos or other audio/visual files related to the particular product. Such files may instructional, promotional, informational or of any other nature. Videos could be formulated to show how a product changes in appearance over a pH or temperature range, for example, or to instruct the customer how to use the product. Alternately, the videos may be advertisements or other promotional materials.

Each of the various interface features 520, 504, 506, 508, 510 may provide information in any manner. In various embodiments, clicking or otherwise selecting the relevant interface feature results in file (e.g., a PDF document), web page or other document being presented in the customer's web browser. In other embodiments, an intermediate window may be presented if multiple files/documents of any type are associated with a particular product. If a particular product has multiple tip sheets available, for example, selecting interface feature 504 may result in an intermediate window that lists the different tips are available and that allows the customer to select the particular document for subsequent viewing. Similar constructs could be applied in connection with any other information features shown in FIG. 5.

FIG. 5 also shows a link 512 to a re-order feature that allows the customer to order the particular product. Online purchases may be processed in any manner, using any conventional shopping cart or other features. In an exemplary embodiment, the customer would select a quantity for purchase and provide identification information (e.g., customer name, address, phone number and the like) along with payment information (e.g., credit card information, PAYPAL or other online payment service information, corporate purchase order numbers, and/or the like). Orders may be processed using conventional e-commerce techniques and structures as desired.

Using the various systems and techniques described herein, then, a customer can be provided with information about a particular product sample that is in the possession of the customer. The customer provides an identifier that identifies the product sample (e.g., by its manufacturing lot, UPC, SKU, serial number or the like), and this identifier is used to retrieve specific information regarding to the particular product that is in the customer's possession. Such information might include, for example, safety information (e.g., an MSDS) as well as any additional usage information that allows the customer to use the product sample that is in his or her possession. By obtaining information based upon an identifier that is provided with the product sample, the customer can obtain information that is uniquely relevant to the particular sample in the customer's possession. Ingredients, recall information and/or properties that are specific to the product sample's particular manufacturing lot, for example, can be provided. This allows the customer to make appropriate use of the product sample.

Various systems and techniques for providing information associated with a product sample are therefore described. As noted at the outset, these techniques and systems may be variously applied to information associated with any soft of products or components of products, including those associated with any cosmetic, personal care, chemical or other industry as appropriate.

As used herein, the word “exemplary” means “serving as an example, instance, or illustration”. “Exemplary” embodiments are not intended as models to be literally duplicated, but rather as examples that provide instances of embodiments that may be modified or altered in any way to create other embodiments. Any implementation described herein as “exemplary” is not necessarily to be construed as preferred or advantageous over other implementations.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. Various changes may be made in the function and arrangement of elements described without departing from the scope of the invention and its legal equivalents.

What is claimed is:

1. A method executable by a server system for providing information associated with a particular product to a customer possessing a particular product, the method comprising:
receiving, by the server system, an identifier from the customer, wherein the identifier is provided with the particular product and uniquely identifies the particular product;
obtaining the information associated with the particular product at the server system based upon the received identifier, wherein the information comprises safety information and usage information that are both associated with the particular product; and
providing the information from the server system to the customer to thereby allow the customer to use the particular product that is in the customer's possession.

2. The method of claim 1 wherein the identifier uniquely identifies the particular product by a particular production lot, and wherein the information associated with the particular product is at least partially associated with the particular production lot.

3. The method of claim 2 wherein the identifier comprises at least one of a universal product code (UPC) value and a stock keeping unit (SKU) number.

4. The method of claim 1 wherein the safety information comprises a material safety data sheet.

5. The method of claim 1 wherein the usage information comprises a tip sheet comprising instructions for using the sample of the particular product.

6. The method of claim 1 wherein the usage information comprises a claim sheet that comprises information in support of a marketing claim about the particular product.

7. The method of claim 1 wherein the usage information comprises a formula for a consumer product that incorporates the particular product.

8. The method of claim 1 further comprising receiving an instruction at the server system from the customer to purchase an additional quantity of the particular product.

9. The method of claim 1 wherein the information further comprises regulatory information associated with the particular product.

10. The method of claim 1 wherein the particular product is a particular chemical component.

11. The method of claim 10 wherein the usage information comprises a formula for at least one cosmetic or personal care product that incorporates the particular chemical component.

12. A method executable by a server system for providing information associated with a particular product that is a component of an end product to a customer possessing a sample of the particular product, the method comprising:
receiving, by the server system, an identifier from the customer, wherein the identifier is provided with the particular product and uniquely identifies the particular product based upon a production lot of the particular product;
obtaining the information associated with the particular product at the server system based upon the received identifier, wherein the information comprises chemical nomenclature information about the particular product, safety information associated with the particular product, and usage information that comprises a formula for the end product comprising the particular product; and
providing the information from the server system to the customer to thereby allow the customer to create the manufactured product based upon the formula and the sample of the particular product that is in the customer's possession.

13. The method of claim 12 wherein the safety information associated with the particular component product comprises a material safety data sheet.

14. The method of claim 12 wherein the information further comprises a tip sheet comprising instructions for using the particular component product, a claim sheet that comprises information in support of a marketing claim about the particular component product, and regulatory information associated with the particular component product.

15. The method of claim 12 further comprising receiving an instruction at the server system from the customer to purchase an additional quantity of the particular component product.

16. A system for providing information associated with a plurality of particular products to a customer possessing a sample of one of the particular products, the system comprising:
an interface to a digital network;
a database comprising the information associated with each of the plurality of particular products, wherein the information comprises, for each of the particular products, both safety information and usage information that are associated with an identifier that is provided with the particular product; and
a controller in communication with the interface and the database, wherein the controller is configured to receive a particular identifier from the customer via the digital network, wherein the particular identifier is associated with the sample of the particular product and uniquely identifies the product, and wherein the controller is further configured to obtain the information associated with the particular product from the database based upon the particular identifier and to provide the information associated with the particular product to the customer to thereby allow the customer to use the sample of the particular product that is in the customer's possession.

17. The system of claim 16 wherein the safety information associated with the particular product comprises a material safety data sheet.

18. The system of claim 16 wherein the information associated with each of the plurality of particular products further comprises a tip sheet comprising instructions for using the sample of the particular product, a claim sheet that comprises information in support of a marketing claim about the particular product, and regulatory information associated with the particular product.

19. The system of claim 16 wherein the controller is further configured to receive an instruction from the customer via the digital network to purchase an additional quantity of the particular product.

20. The system of claim 16 wherein the identifier uniquely identifies the particular product by a particular production lot, and wherein the information associated with the particular product is at least partially associated with the particular production lot.
